(19) United States
(12) Patent Application Publication
(10) Pub. No.: US 2005/0162504 A1
(43) Pub. Date: Jul. 28, 2005

(54) Line thermal head and thermal-transfer line printer

(75) Inventors: Hirotoshi Terao, Fukushima-ken (JP); Tomoko Wauke, Fukushima-ken (JP); Hisashi Hoshino, Fukushima-ken (JP); Tsuneyuki Sasaki, Fukushima-ken (JP); Takahito Maruyama, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/036,313

(22) Filed: Jan. 14, 2005

(30) Foreign Application Priority Data
Jan. 23, 2004 (JP) 2004-015597
Jul. 2, 2004 (JP) 2004-197133

(51) Int. Cl. B41J 2/325; B41J 11/00; B41J 33/00; B41J 35/16

(52) U.S. Cl. 347/176

(57) ABSTRACT

In order to improve the traveling stability of an ink ribbon, a thermal head having a structure in which an edge of one surface of a substrate, lying downstream with respect to the traveling direction of an ink ribbon, is formed so as to have a curved shape projecting most downstream with respect to the traveling direction of the ink ribbon at the widthwise central portion of the ink ribbon or a thermal-transfer line printer having a structure in which a separation member separating the ink ribbon from a paper sheet and a tension-exerting section are independently formed from each other is provided.

### BACKGROUND OF THE INVENTION

1. Field of the Invention

The present invention relates to a line thermal head suitable for use in improving the traveling stability of an ink ribbon and also to a thermal-transfer line printer.

2. Description of the Related Art

A known thermal-transfer line printer has a structure in which a line thermal head having a length corresponding to the longitudinal or horizontal printing range of a sheet of paper (hereinafter, referred to as a paper sheet) serving as a recording medium is abutted against a platen through a wide ink ribbon such as an ink film or an ink sheet and the paper sheet, and, when a plurality of heating elements arranged so as to correspond to the printing width (recording width) in the longitudinal direction of the line thermal head is selectively driven and heated, ink of the ink ribbon is transferred to the paper sheet so as to achieve printing (recording) on the basis of printing information (recording information) with the ink ribbon and the paper sheet being transported in this abutment state.

Referring to FIGS. 19 to 21, the thermal-transfer line printer will be described.

In a known thermal-transfer line printer 101 shown in FIG. 19, a paper sheet (recording medium) 104 transported inside the printer through an inlet (not shown) disposed at an IN position (on the right in FIG. 19) and an ink ribbon 105 delivered from a delivery roller 113 of an ink cartridge 112 are transported toward a line thermal head 103 and a platen roller 102 (toward a thermal transfer position PP) and are pressed by the line thermal head 103 and the platen roller 102. The line thermal head 103 includes a large number of heating elements 103h disposed in a row arrangement so as to lie perpendicular to the transport direction of the sheet paper, and, when the heating elements 103h are selectively heated, ink of the ink ribbon 105 lying at a transfer position PP is transferred to the paper sheet 104. Then, the paper sheet 104 is separated from the ink ribbon 105 at a separation section SP. The paper sheet 104 having ink transferred thereto is transported along the arrow indicated in the figure while being pressed between a paper-feeding roller 110 and a pressure roller 111 and is discharged from an outlet (not shown) at an OUT position. Also, the printed ink ribbon 105 is taken up by a take-up roller 114 installed in the cartridge 112.

As shown in FIG. 20, the line thermal head 103 is disposed above the rotatable platen roller 102 such that a printing surface 103a thereof faces the peripheral surface of the platen roller 102.

Also, the line thermal head 103 is fixed to the lower surface of a head-fixing member (not shown) composed of a metal material such as an aluminum alloy, which is light and excellent in heat dissipation (thermal conduction).

In the printing state of the thermal-transfer line printer 101, the paper sheet 104 and the ink ribbon 105 are supplied one after another in the order from the platen roller 102, between the line thermal head 103 and the platen roller 102.

The printing surface 103a of the line thermal head 103 in the printing state of the thermal-transfer line printer 101 is abutted against the rear surface of the ink ribbon 105, having no ink applied thereon.

Further, the line thermal head 103 includes a substantially flat substrate 106 and the plurality (the large number) of heating elements 103h disposed on one surface of the substrate 106, and the one surface of the substrate 106 serves as the printing surface 103a of the line thermal head 103. The plurality of the heating elements 103h is arranged on the one surface of the substrate 106 so as to lie in a direction perpendicular to the transport direction (feeding direction) of the paper sheet 104, that is, a direction indicated by an arrow A in the figure and also to cover the length (printing width) of the printing area of the paper sheet 104 in a line direction.

That is, the printing surface 103a of the line thermal head 103 has the heating elements 103h disposed thereon in its longitudinal direction so as to correspond to the printing width.

The substrate 106 has drivers in a form of an LSI chip, fixed thereto with sealing material such as thermosetting resin, for driving the respective heating elements 103h.

In addition, the line thermal head 103 is detachable from the platen roller 102 with an attaching-detaching mechanism (not shown). In a head down state in which the line thermal head 103 is abutted against the platen roller 102, the paper sheet 104 is subjected to printing. The abutment position at which the line thermal head 103 and the platen roller 102 are abutted against each other in the printing state of the thermal-transfer line printer 101 serves as a printing position PP where which ink of the ink ribbon 105 is transferred to the paper sheet 104 so as to perform printing. In the printing state of the thermal-transfer line printer 101, the ink ribbon 105 travels together with the paper sheet 104. The traveling direction of the ink ribbon 105 is indicated by an arrow B in the figure.

The line thermal head 103 has a separation plate 108 formed with a rigid metal material so as to have a substantially flat shape disposed downstream with respect to the paper feeding direction. By abutting the separation plate 108 against the rear surface of the ink ribbon 105 having used for printing and providing a tension to the ink ribbon 105 for being taken up, the ink ribbon 105 having used for printing can be easily and reliably separated from the paper sheet 104. The separation plate 108 having such a structure is fixed to the most downstream portion of the head-fixing member with respect to the paper feeding direction or arranged with an exclusive fixing member, downstream of the line thermal head 103 with respect to the feeding direction.

In addition to separating the ink ribbon 105 having used for printing from the paper sheet 104, as shown in FIG. 21 in an exaggerated manner, the separation plate 108 achieves the traveling stability of the ink ribbon 105 by forming a portion of the abutment surface against the ink ribbon 105, lying downstream with respect to the paper feeding direction, so as to have an arched shape, that is, a curved shape projecting most at the central portion of the ink ribbon 105, and thus by making the tension likely to be non-uniform in the width direction of the ink ribbon 105, in other words, to be small at the central portion and large at both ends of the ribbon 105, substantially uniform in the width direction (see Japanese Unexamined Patent Application Publication No. 2002-144614).

Unfortunately, since the known separation section SP serves so as to separate the recording medium 104 and the ink ribbon 105 from each other and, at the same time, to provide the ink ribbon 105 with a certain constant tension for preventing its waviness, as shown in FIG. 21, the distance L between the heating elements 103h and the separation section SP (hereinafter, referred to as the separation distance varies in accordance with the curved shape of the separation plate 108. This problem directly affects a time from thermal transfer to separation (hereinafter, referred to as a separation time) between the paper sheet 104 and the ink ribbon 105 from each other. For example, a difference in the separation distances L at an end 108e and a central portion 108c of the separation plate from each other causes a positional difference in separation times, thereby resulting in reduction in printing quality or excessive noise. Unfortunately, when the separation plate 108 is formed so as to be parallel to the arrangement direction of the heating elements 103h, a suitable tension can not be provided to the ink ribbon 105; resultantly, the problems of surface waviness and crease having existed before the proposal of curving the separation plate 108 remain unsolved.

It is known that the non-uniform strength of the ink ribbon 105 in its width direction is caused by deformation of the longitudinal central portion of a ribbon shaft, disposed downstream of the line thermal head 103 or the separation plate 108 with respect to the traveling direction of the ink ribbon 105 and allowing the ink ribbon 105 to travel or by deformation of a guide shaft regulating the traveling path of the ink ribbon 105, and that, especially when the tension of the ink ribbon 105 is large, the ink ribbon 105 passing through the line thermal head 103 tends to have small and large tensions at the widthwise central portion and at both ends thereof respectively, thereby leading to a high risk of causing crease of the ink ribbon 105.

### SUMMARY OF THE INVENTION

The present invention has been made in view of these problems; accordingly, it is an object of the present invention to provide a line thermal head or a thermal-transfer line printer improving the traveling stability of an ink ribbon.

A line thermal head according to the present invention has a structure in which heating elements for partially melting ink of an ink ribbon are longitudinally arranged on one surface of a substantially flat substrate, and an edge of the one surface of the substrate, lying downstream with respect to the traveling direction of the ink ribbon, is formed so as to have a curved shape projecting most downstream at the widthwise central portion of the ribbon.

Also, in the line thermal head according to the present invention, the one surface of the substrate is formed so as to have a curved surface projecting most toward the ink ribbon at the widthwise central portion of the ink ribbon.

In addition, in the line thermal head according to the present invention, the edge of the one surface of the substrate, lying downstream with respect to the traveling direction of the ink ribbon, serves as a separation section separating the ink ribbon from a recording medium.

A thermal-transfer line printer according to the present invention includes a thermal head; and a separation member exerting a tension on an ink ribbon for separation from a recording medium. The separation member has a separation section separating the ink ribbon from the recording medium and a tension-exerting section formed therein so as to be independent from each other.

Also, in the thermal-transfer line printer according to the present invention, the separation section of the separation member is disposed closer to a thermal transfer position than the tension-exerting section.

In addition, in the thermal-transfer line printer according to the present invention, the separation section of the separation member is formed so as to be parallel to the arrangement direction of heating elements used for thermal transfer.

Further, in the thermal-transfer line printer according to the present invention, the widthwise central portion of the tension-exerting section of the separation member is formed so as to be convex.

Furthermore, in the thermal-transfer line printer according to the present invention, the separation member is formed independently from a substrate of the thermal head and fixed to the substrate.

The line-thermal head according to the present invention has very excellent advantages such as an improvement in traveling stability of the ink ribbon.

Also, the thermal-transfer line printer according to the present invention have excellent advantages that a suitable tension can be provided to an ink ribbon having undergone thermal transfer and that the separation distance can be made uniform regardless of the separation section, thereby improving the printing quality thereof.

### BRIEF DESCRIPTION OF THE DRAWINGS

FIG. 1 is a perspective view of an essential part of a line thermal head according to a first embodiment of the present invention, illustrating in an exaggerated manner;

FIG. 2 is an elevational view of the line thermal head;

FIG. 3 is a plan view of the line thermal head;

FIG. 4 is a right side view of the line thermal head;

FIG. 5 is a perspective view of an essential part of a line thermal head according to a second embodiment of the present invention, illustrated in an exaggerated manner;

FIG. 6 is an elevational view of the line thermal head;

FIG. 7 is a plan view of the line thermal head;

FIG. 8 is a right side plan view of the line thermal head;

FIG. 9 is a perspective view of an essential part of a line thermal head according to a third embodiment of the present invention, illustrated in an exaggerated manner;

FIG. 10 is an elevational view of the line thermal head;

FIG. 11 is a plan view of the line thermal head;

FIG. 12 is a right side view of the line thermal head;

FIG. 13 is a perspective view of a thermal-transfer line printer according to the present invention, viewed from the bottom thereof, wherein a thermal transfer section of its thermal head serves as the bottom thereof;

FIG. 14 is a perspective view of a separation member, viewed from its separation section (from the bottom thereof);

FIG. 15 is an elevational view of the separation member;

FIG. 16 is a left side view of the separation member;

FIG. 17 is a bottom view of the separation member;

FIG. 18 is a plan view of the separation member;

FIG. 19 is an elevational view of the major structure of a known thermal-transfer line printer;

FIG. 20 is a diagrammatic view of an essential part of an example line thermal head and its vicinity of the known thermal-transfer line printer; and

FIG. 21 is a plan view of a separation member and its vicinity of the known thermal-transfer line printer.

### DESCRIPTION OF THE PREFERRED EMBODIMENTS

The present invention will be described in accordance with embodiments shown in the attached drawings.

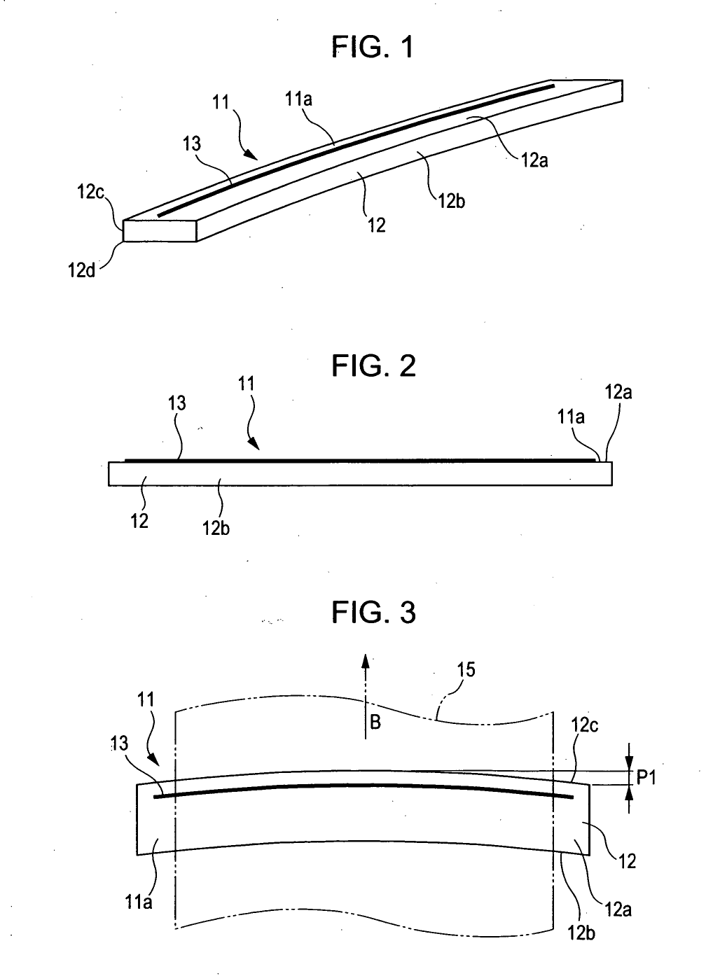

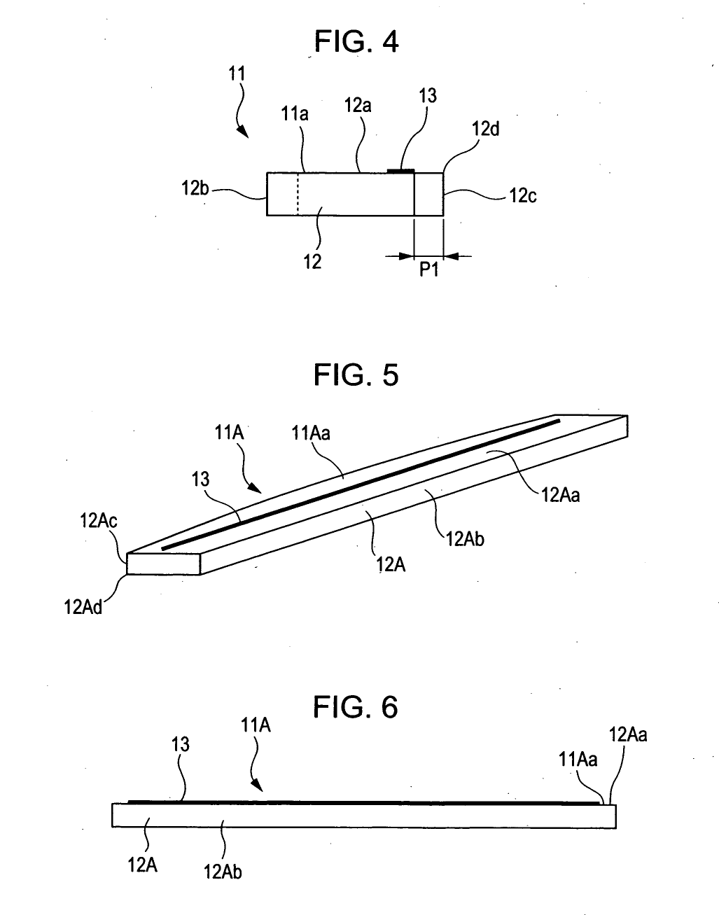

FIGS. 1 to 4 are respectively a perspective view, an elevational view, a plan view, and a right side view of an essential part of a line-thermal head 11 according to a first embodiment of the present invention,.

As shown in FIGS. 1 to 4, the line thermal head 11 according to the present embodiment includes a substantially flat substrate 12 and a plurality of heating elements 13 for partially melting ink of an ink ribbon 15 indicated by an imaginary line in FIG. 3. The plurality of heating elements 13 is disposed on an upper surface 12a of the substrate 12, serving as a printing surface 11a of the line thermal head 11.

The substrate 12 has end surfaces 12b and 12c on its both longitudinal sides, which lie respectively upstream and downstream with respect to the traveling direction of the ink ribbon 15 shown by the imaginary arrow B indicated in FIG. 3 (the same direction as the paper feeding direction or the transporting direction of a paper sheet) and which extend substantially parallel to each other. Also, as shown in FIGS. 1 to 4 in an exaggerated manner, each of the end surfaces 12b and 12c has an curved shape or an arch shape in the present embodiment, projecting most downstream with respect to the traveling direction of the ink ribbon 15 at the longitudinally central portion, that is, at the central portion with respect to the width direction of the ink ribbon 15 shown horizontally in the FIGS. 2 and 3 (hereinafter, simply referred to as the width direction),.

As the shape of the substrate 12, it is sufficient that an edge 12d of the upper 12a serving as the printing surface 11a and having the ink ribbon 15 thereon, lying at least downstream with respect to the traveling direction of the ink ribbon 15, has a curved shape projecting most downstream with respect to the traveling direction of the ink ribbon 15 at its central portion. As the thermal line head 11 is longer, a projection amount P1 from both ends of the edge 12d of the substrate 12 lying downstream with respect to the traveling direction of the ink ribbon 15 on the upper surface 12a of the substrate 12 should be greater. For example, when the line thermal head 11 is 50 mm long, 100 mm long, 150 mm long, 200 mm long, or 250 mm long, the projection amount P1 should be respectively set in the approximate range of 0 to 60 μm, 30 to 120 μm, 50 to 180 μm, 65 to 240 μm, or 80 to 300 μm. When the projection amount P1 is smaller than the corresponding range, the tension likely to become non-uniform in the width direction of the ink ribbon 15 cannot be corrected, and when the projection amount P1 exceeds the corresponding range, a different tension tends to be provided to the ink ribbon 15 in the width direction.

As shown in FIG. 3, the plurality of heating elements 13 arranged on the upper surface 12a of the substrate 12 lies in the longitudinal direction of the substrate 12, that is, in the horizontal direction in the figure of FIG. 3. In other words, in the same fashion as the end surface 12c of the upper surface 12a of the substrate 12, lying downstream with respect to the traveling direction of the ink ribbon 15 on the upper surface 12a of the substrate 12, the plurality of heating elements 13 is arranged so as to have a curved shape or an arched shape in the present embodiment, most projecting downstream with respect to the traveling direction of the ink ribbon 15 at its widthwise central portion, and also to cover the length (printing width) of the printing area (not shown) in a line direction.

Also, the line thermal head 11 according the present embodiment has a structure in which the upper surface 12a of the substrate 12 shown in the upper part of FIG. 1 serves as the flat printing surface 11a, and, in the printing state, the heating elements 13 are abutted against the rear surface having no ink applied thereon, of the ink ribbon 15 indicated by the imaginary line in FIG. 3.

The line thermal head 11 is installed in a thermal-transfer line printer such that the printing surface 11a faces a platen of the printer in a similar fashion to the known one, and that a paper sheet serving as a recording medium and the ink ribbon 15 are supplied one after another in the order from the platen, between the platen and the line thermal head 11 in a printing state.

The line thermal head 11 according to the present embodiment can be easily made in its manufacturing step, for example, in a mounting step of mounting the heating elements 13 on the substrate 12; more particularly, it can be made by thermally deforming the substrate 12 so as to be warped in a heating step in which drivers for driving the respective heating elements 13 are mounted on the substrate 12 and then fixed to the substrate 12 with a sealing material such as a thermosetting resin.

Since the other structures thereof are the same as those of the known line thermal head, their detailed descriptions are omitted.

Advantages of the present embodiment having the above described structure will be described.

With the line thermal head 11 according to the present embodiment, the edge 12d of the upper surface 12a of the substrate 12, lying downstream with respect to the traveling direction of the ribbon 15 is formed so as to have a curved shape projecting most downstream with respect to the traveling direction of the ink ribbon 15 at its widthwise central portion, whereby the tension likely to be non-uniform in the width direction of the ink ribbon 15 is corrected for being uniform over the ink ribbon 15 in the width direction.

Accordingly, with the line thermal head 11 according to the present embodiment, the traveling stability of the ink ribbon 15 can be easily and reliably improved.

Also, with the line thermal head 11 according to the present embodiment, the edge 12d of the upper surface 12a of the substrate 12, lying downstream with respect to the traveling direction of the ribbon 15, serves as a conventional separation plate which is formed independently, thereby reducing the number of parts and thus leading to a compact and low-cost printer. As a matter of course, although the separation plate may be disposed, in this case, the separation plate is not needed to have a curved shape for achieving the traveling stability of the ink ribbon 15 and is also easily fixed.

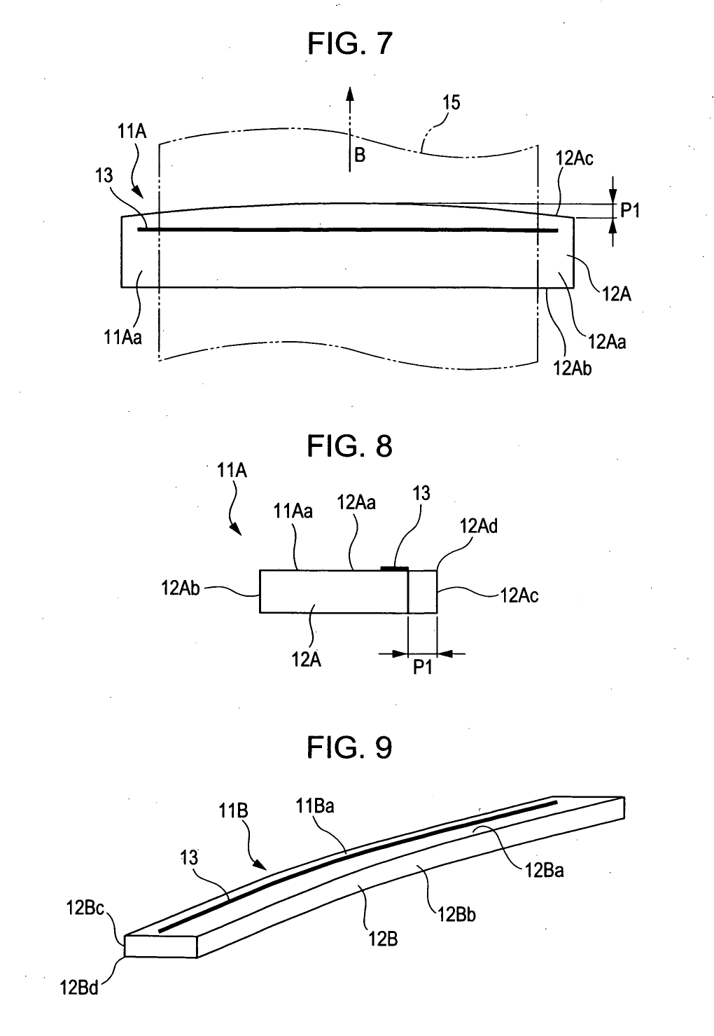

FIGS. 5 to 8 are respectively a perspective view, an elevational view, a plan view, and a right side view of an essential part of a line-thermal head 11A according to a second embodiment of the present invention.

The line thermal head 11A according to the present embodiment has a structure in which an edge 12Ad of an upper surface 12Aa of a substrate 12A, lying downstream with respect to the traveling direction of the ink ribbon 15, is formed so as to have a curved shape projecting most downstream with respect to the traveling direction of the ink ribbon 15 at its widthwise central portion.

More particularly, the line thermal head 11A according to the present embodiment has a structure in which, upon forming the substrate 12A so as to have a predetermined shape, each of an end surface 12Ac and the edge 12Ad of the substrate 12A, lying downstream with respect to the traveling direction of the ink ribbon 15, is formed with a mechanical process such as a dicing process so as to have a curved shape or an arched shape projecting downstream most with respect to the traveling direction of the ink ribbon 15 at its widthwise central portion, and an end surface 12Ab of the substrate 12A lying upstream with respect to the traveling direction of the ribbon 15 is formed in a straight shape.

The heating elements 13 of the line thermal head 11A according to the present embodiment are straightly arranged downstream with respect to the traveling direction of the ink ribbon 15 on the upper surface 12Aa of the substrate 12A and along the longitudinal direction of the line thermal head 11A so as to cover the length (printing width) of the printing area (not shown) in a line direction, and the upper surface 12Aa of the substrate 12A serves as a printing surface 11Aa.

Since the other structures thereof are the same as those of the line thermal head 11 according to the foregoing first embodiment, their detail descriptions are omitted.

With this structure, the line thermal head 11A according to the present embodiment has the same advantages as those of the line thermal head 11 according to the first embodiment.

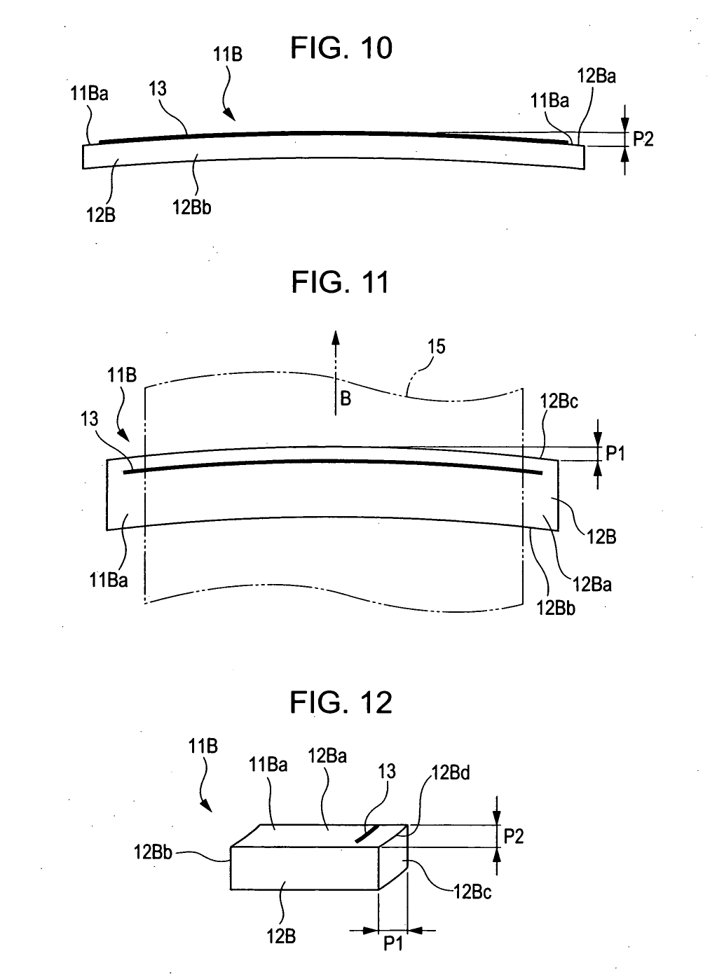

FIGS. 9 to 12 are respectively a perspective view, an elevational view, a plan view, and a right side view of an essential part of a line thermal head 11B according to a third embodiment of the present invention.

The line thermal head 11B according to the present embodiment has a structure in which each of an end surface 12Bc and an edge 12Bd of an upper surface 12Ba of a substrate 12B, lying downstream with respect to the traveling direction of the ink ribbon 15, is formed so as to have a curved shape projecting most downstream with respect to the traveling direction of the ink ribbon 15 at its widthwise central portion, and also, the entire upper surface 12Ba is formed so as to have a curved surface projecting most toward the ink ribbon 15 at its widthwise central portion.

An projection amount P1 from both ends of each of the end surface 12Bc and the edge 12Bd of the upper surface 12Ba lying downstream with respect to the traveling direction of the ink ribbon 15 and a convex amount P2 from both ends of the upper surface 12Ba should be greater as the line thermal head 11B is longer. For example, when the line thermal head 11B is 50 mm long, 100 mm long, 150 mm long, 200 mm long, or 250 mm long, the projection amount P1 should be respectively in the order of 0 to 60 μm, 30 to 120 μm, 50 to 180 μm, 65 to 240 μm, or 80 to 300 μm, and the convex amount P2 should be respectively in the approximate range of 0 to 50 μm, 20 to 100 μm, 30 to 150 μm, 40 to 180 μm, or 50 to 200 μm.

Meanwhile, an end surface 12Bb of the substrate 12B lying upstream with respect to the traveling direction of the ink ribbon 15 may be straightly formed in the same fashion as the end surface 12Ab of the line thermal head 11A according to the foregoing second embodiment.

The lower surface of the substrate 12B lying opposite to the upper surface 12Ba of the same may be formed flat.

FIGS. 9 to 12 illustrate the projection amount P1 and the convex amount P2 in an exaggerated manner.

As shown in the figures, in the same fashion as the edge 12Bd of the upper surface 12Ba of the substrate 12B, lying downstream with respect to the traveling direction of the ink ribbon 15, the heating elements 13 of the line thermal head 11B according to the present embodiment are arranged so as to have a curved shape, or an arched shape in the present embodiment, projecting most downstream with respect to the traveling direction of the ink ribbon 15 at its widthwise central portion and also to cover the length (printing width) of the printing area (not shown) in a line direction, and the upper surface 12Ba of the substrate 12B serves as a printing surface 11Ba.

Since the other structures thereof are the same as those of the line thermal head 11 according to the foregoing first embodiment, their detail descriptions are omitted.

With this structure, the line thermal head 11B according to the present embodiment has the same advantages as those of the line thermal head 11 according to the first embodiment and also expand an allowable range in which the tension likely to be non-uniform in the width direction of the ink ribbon 15 can be corrected.

Accordingly, with the line thermal head 11B according to the present embodiment, the traveling stability of the ink ribbon 15 is easily and reliably improved.

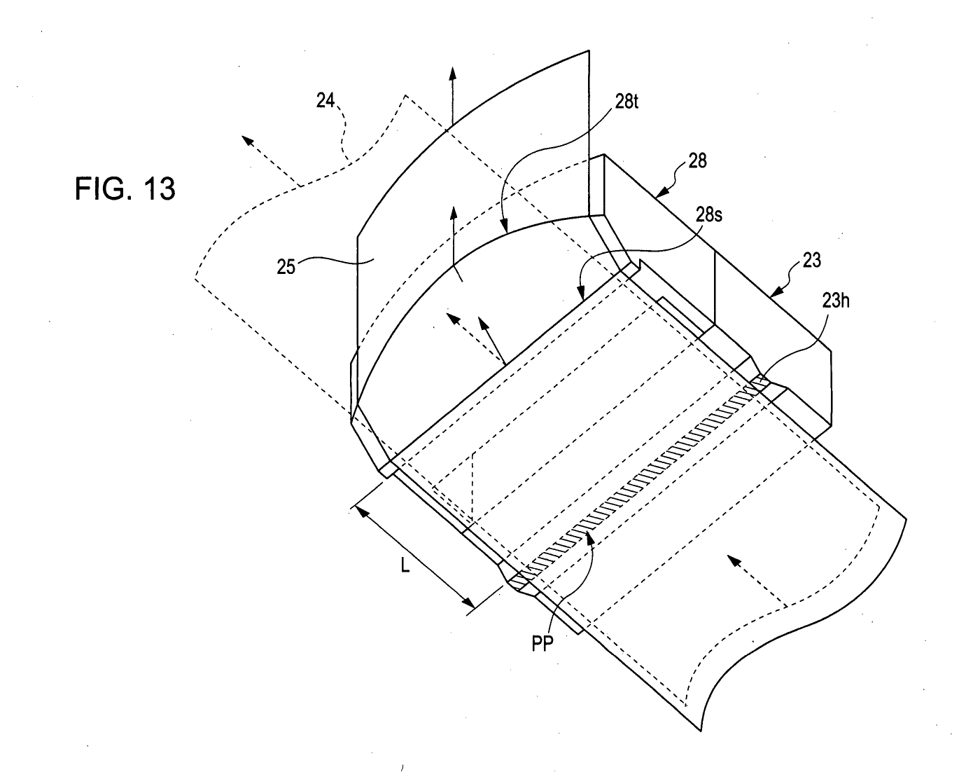

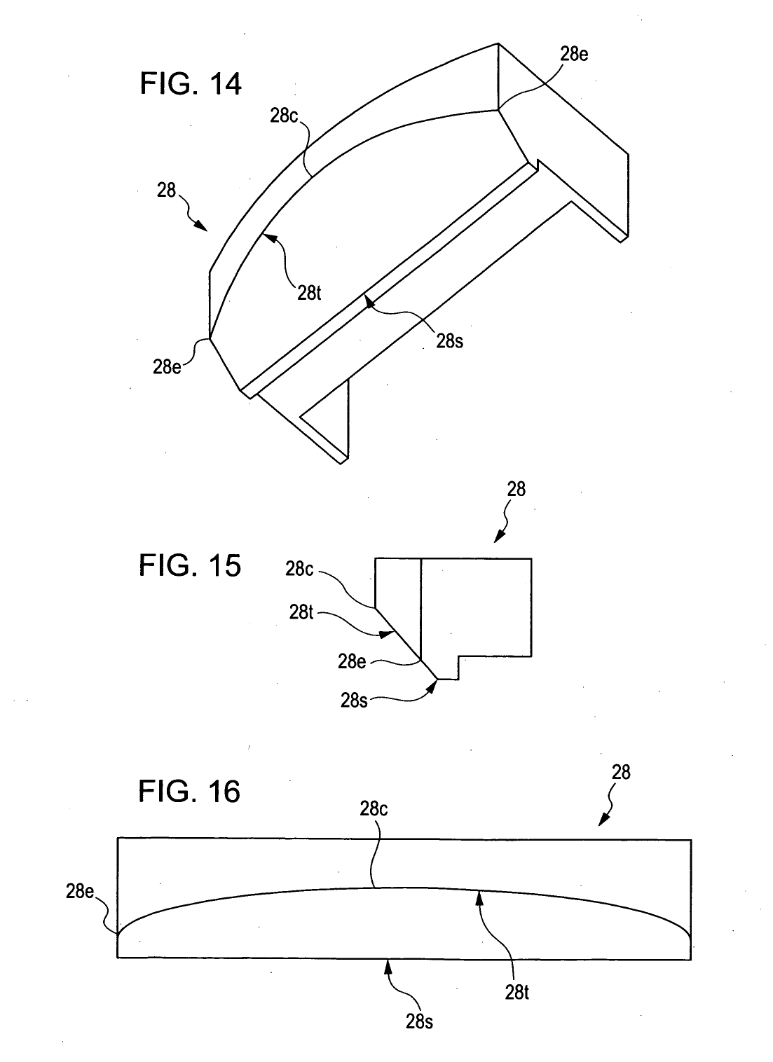

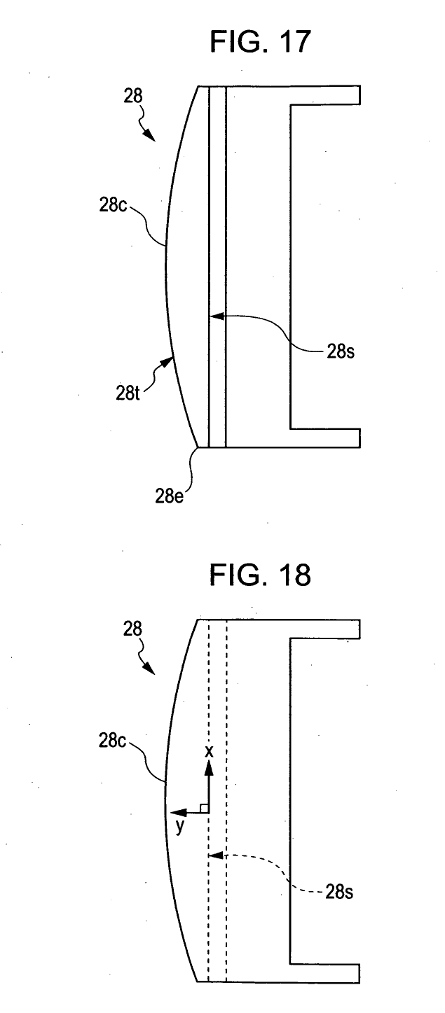

Referring now to FIGS. 13 to 18, a thermal-transfer line printer 21 according to an embodiment of the present invention will be described.

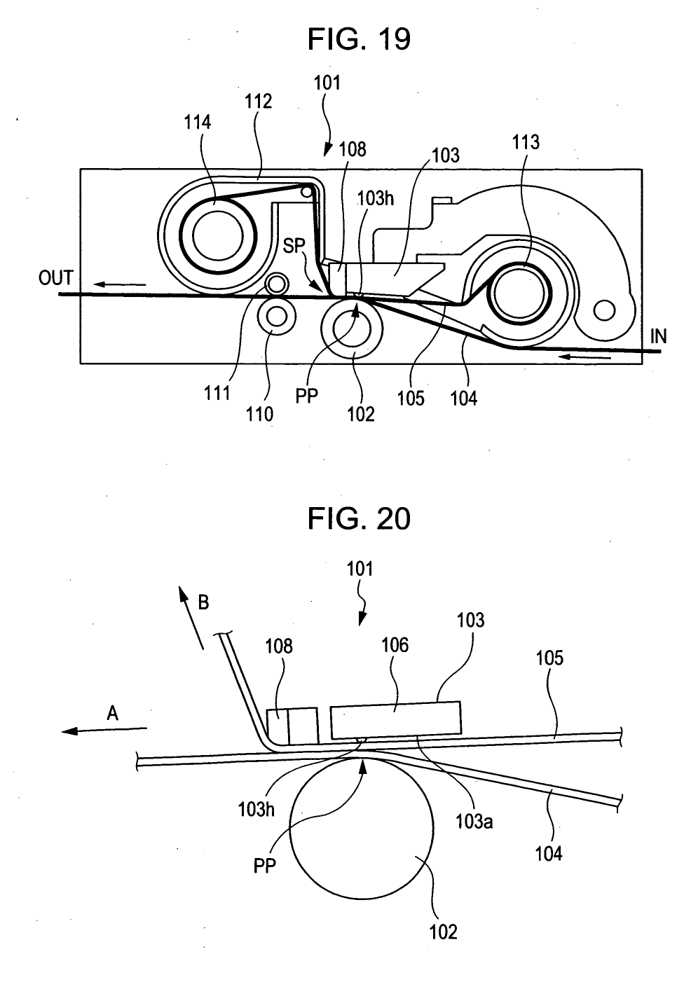

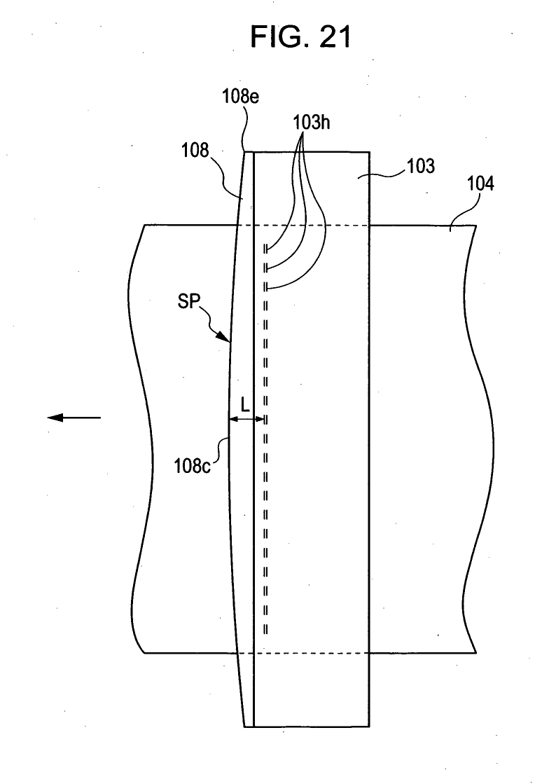

The thermal-transfer line printer 21 according to the present invention is mainly characterized in two points that an ink ribbon and a recording medium, both having undergone thermal transfer with a thermal head, are suitably separated from each other, and that the ink ribbon is prevented from surface waviness by having a tension exerted thereon; hence the thermal head and its peripheral parts will be mainly described. To this end, the overall structure of the thermal-transfer line printer and its printing method will be described with reference to FIG. 19 to which the known one refers.

FIG. 13 illustrates a thermal head 23 and a separation member 28 according to an embodiment of the present invention. The separation member 28 has a separation section 28s disposed away from heating elements 23h by a separation distance L so as to be parallel to the arrangement direction of the heating elements 23h. For example, when the printing speed of the thermal-transfer line printer 21 is 0.5 (about 12.7 mm) per second, the separation distance L of the separation member 28 is preferably set at about 3.5 to 4.0 mm. The separation distance L corresponds to a time of about 0.3 second from thermal transfer to separation (hereinafter, referred to as a separation time). Since the separation time represents a cooling time of ink of an ink ribbon 25 undergoing thermal transfer at a transfer position PP (see FIG. 13), it is preferable that the separation time be determined in accordance with a cooling level of the ink thermally transferred to a paper sheet 24, and the separation distance L be set correspondingly. By forming the separation section 28s so as to be parallel to the heating elements 23h, the printing quality over the entire width of the ink ribbon 25 can be uniform.

The separation member 28 has a tension-exerting section 28t formed downstream of the separation section 28s with respect to the traveling direction of the ink ribbon 25 in order to exert a tension on the ink ribbon 25. The tension-exerting section 28t is formed so as to be convex at its widthwise central portion. For example, when the length of the separation member 28 in its width direction (in the X-direction in FIG. 18) is 70 mm, the central portion of the tension-exerting section 28t is preferably formed so as project most by an amount of about 0.3 mm from longitudinal both ends 28e of the separation member 28 in its projecting direction (in the Y-direction in FIG. 18) as shown in FIG. 18. Meanwhile, the curved portion of the separation section 28s shown in FIGS. 13 to 18 is illustrated in an exaggerated manner for better understanding.

The separation member 28 is preferably composed of copper, aluminum, or an alloy mainly including at least one of these metals which is more excellent in balance between heat dissipation and cost effectiveness when compared to other metals. Although being inferior to these metals with respect to heat dissipation, a resin material which is easily processed and inexpensive may be alternatively used. The separation member 28 is firmly fixed to the thermal head 23 with a known fixing method such as insertion, bonding, or screwing.

An operation of the thermal-transfer line printer 21 according to the present invention will be described.

The paper sheet 24 and the ink ribbon 25 transported from the lower right side of the figure of FIG. 13 are heated by the heating elements 23h arranged at the thermal transfer position PP, and, with this heating, ink applied on the ink ribbon 25 is transferred to the paper sheet 24.

The paper sheet 24 having the ink transferred thereto is transported together with the ink ribbon 25 away from the heating elements 23h by an amount of the separation distance L, and the ink ribbon 25 is separated from the paper sheet 24 at the separation section 28s formed parallel to the arrangement direction of the heating elements 23h. The separation section 28s is formed parallel to the arrangement direction of the heating elements 23h in order to make the separation distance L uniform along the width direction of the ink ribbon 25 and the separation time of any portion of the paper sheet 24 uniform. Also, the separation section 28s is disposed away from the heating elements 23h by the separation distance L in order to keep a certain cooling time for fixing the ink thermally transferred to the paper sheet 24 and to prevent separation of the ink from a paper sheet 24. In other words, with the separation section 28s formed so as to meet the above-described purposes, the printing quality of the printer is improved, thereby reliably preventing conventional deterioration in printing quality.

The paper sheet 24 having the ink ribbon 25 separated therefrom is discharged outside the printer while being pressed and transported between a paper-feeding roller 110 and a pressure roller 111 as shown in FIG. 19 (the paper sheet shown in FIG. 19 is represented by reference number 104 in place of 24).

As shown in FIG. 13, the ink ribbon 25 having separated from the paper sheet 24 has a tension exerted thereon through the tension-exerting section 28t. Since the widthwise central portion of the tension-exerting section 28t of the separation member 28 guiding the transport of the ink ribbon 25 is formed so as to be approximately convex, the separation member 28 including the tension-exerting section 28t is capable of exerting a tension on the ink ribbon 25 having expansion and contraction therein generated by heat applied from the heating elements 23h and causing surface waviness.

In the thermal-transfer line printer 21 according to the present invention, although not shown, the tension-exerting section 28t can be formed independently from the separation member 28. In this case, the independently formed separation member 28 and the tension-exerting section 28t formed by curving a flat member composed of metal, synthetic resin, or the like are fixed to each other with a known method. It is up to the manufacturing cost of the printer whether the separation member 28 and the tension-exerting section 28t are independently formed from each other.

Then, the ink ribbon 25 having the tension exerted from the tension-exerting section 28t is transported upward in the figure of FIG. 20 and is finally taken up for retrieval by a take-up roller 113 (the ink ribbon shown in FIG. 20 is represented by reference number 105 in place of 25).

With the thermal-transfer line printer 21 having the above-described structure according to the present invention, by making the separation distance L uniform and a tension exerted on the widthwise central portion of the ink ribbon 25 great, unstable traveling, for example, horizontally undulating of the ink ribbon 25 can be solved and suitable cooled separation is achieved, thereby offering very high quality printing.

Although, in the thermal-transfer line printer according to the embodiments of the present invention shown in FIGS. 13 to 18, the tension-exerting section 28t of the separation member 28 is formed in a flat and curved shape without a step, a part of the tension-exerting section 28t may be formed with a step-shaped member (not shown).

The present invention is not limited to the above-described embodiments and can be variously modified if needed.

1. A line thermal head in which heating elements for partially melting ink of an ink ribbon are longitudinally arranged on one surface of a substantially flat substrate,
wherein an edge of the one surface of the substrate, lying downstream with respect to a traveling direction of the ink ribbon, is formed so as to have a curved shape projecting most downstream at a widthwise central portion of the ribbon.

2. The line thermal head according to claim 1, wherein the one surface of the substrate is formed so as to have a curved surface projecting most toward the ink ribbon at the widthwise central portion of the ink ribbon.

3. The line thermal head according to claim 1, wherein the edge of the one surface of the substrate, lying downstream with respect to the traveling direction of the ink ribbon, serves as a separation section separating the ink ribbon from a recording medium.

4. A thermal-transfer line printer, comprising:
a thermal head; and
a separation member exerting a tension on an ink ribbon for separation from a recording medium,
wherein the separation member has a separation section separating the ink ribbon from the recording medium and a tension-exerting section formed therein so as to be independent from each other.

5. The thermal-transfer line printer according to claim 4, wherein the separation section of the separation member is disposed closer to a thermal transfer position than the tension-exerting section.

6. The thermal-transfer line printer according to claim 4, wherein the separation section of the separation member is formed so as to be parallel to an arrangement direction of heating elements used for thermal transfer.

7. The thermal-transfer line printer according to claim 4, wherein a widthwise central portion of the tension-exerting section of the separation member is formed so as to be convex.

8. The thermal-transfer line printer according to claim 4, wherein the separation member is formed independently from a substrate of the thermal head and fixed to the substrate.
